(19) United States
(12) Patent Application Publication
(10) Pub. No.: US 2015/0282242 A1
(43) Pub. Date: Oct. 1, 2015

(54) METHODS AND APPARATUS FOR PROCESSING AN IMS SESSION

(71) Applicant: TELEFONAKTIEBOLAGET L M ERICSSON (PUBL), Stockholm (SE)

(72) Inventors: Emiliano Merino Vazquez, Leganes (ES); Tobias Austrell, Alvsjo (SE); Juan Manuel Fernandez Galmes, Getafe (ES); Bernardo Perez De Villar Caamaño, Madrid (ES)

(21) Appl. No.: 14/431,499

(22) PCT Filed: Oct. 1, 2012
(86) PCT No.: PCT/EP2012/069370

§ 371 Date: Mar. 26, 2015

(51) Int. Cl. H04W 76/02; H04W 8/04; H04L 29/08; H04L 29/06; H04W 88/18

(52) U.S. Cl. CPC H04W 76/028; H04L 65/1016; H04W 88/182; H04L 65/1073; H04L 67/306; H04W 8/04; H04W 88/02

(57) ABSTRACT

According to a first aspect there is provided a method of processing an IP Multimedia Subsystem (IMS) session originated by a User Equipment (UE) after failure of a Serving Call Session Control Function (S-CSCF) that was previously assigned to a user of the UE during registration with the IMS. The method comprises, at a Proxy Call Session Control Function (P-CSCF), upon determining that the P-CSCF is unable to forward a session establishment request for the session to the previously assigned S-CSCF, selecting an alternative S-CSCF from a S-CSCF pool, and sending the session establishment request for the session to the alternative S-CSCF.

### TECHNICAL FIELD

The present invention relates to methods and apparatus for processing an IP Multimedia Subsystem (IMS) session. More particularly, the invention relates to methods and apparatus for processing an IMS session originated by a User Equipment (UE) after failure of a Serving Call Session Control Function (S-CSCF).

### BACKGROUND

The IP Multimedia Subsystem (IMS) is the technology defined by the Third Generation Partnership Project (3GPP) to provide IP Multimedia services over telecommunication networks. The IMS allows a telecommunications system to offer multimedia services to user terminals (referred hereinafter as “user equipment”(UE)). For example, these services can comprise voice, video, text, chat, and combinations thereof. To do so, IMS provides key features to enrich the end-user person-to-person communication experience through the integration and interaction of services. IMS allows new rich person-to-person (client-to-client) as well as person-to-content (client-to-server) communications over an IP-based network. The IMS is able to connect to both PSTN/ISDN (Public Switched Telephone Network/Integrated Services Digital Network) as well as the Internet. In relation to an IMS, a UE may be any device, mobile or stationary, enabled to communicate by radio or any other means with the IMS via an IP-CAN, for instance but not limited to e.g. mobile phone, smart phone, sensors, meters, vehicles, household appliances, medical appliances, media players, cameras, or any type of consumer electronic device, for instance but not limited to television, radio, lighting arrangements, tablet computer, laptop, or PC.

The IMS makes use of the Session Initiation Protocol (SIP) to set up and control calls or sessions between UEs (or UEs and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly.

FIG. 1 illustrates schematically the architecture for the IMS and its relationship to an IP-Connectivity Access Network (IP-CAN). In the IMS Core Network, Call/Session Control Functions (CSCFs) operate as SIP proxies, and interface with other entities such as Border Gateway Control Functions (BGCFs) and Media Resource Function Controllers (MRFCs) amongst others. The 3GPP architecture defines three types of CSCFs, and there can be multiple instances of each type of CSCF within an operator's network. A Proxy CSCF (P-CSCF) is the first point of contact within the IMS for a UE; a Serving CSCF (S-CSCF) provides services to the subscriber; an Interrogating CSCF (I-CSCF) identifies the correct S-CSCF and forwards to that S-CSCF a request received from a UE via a P-CSCF.

The Home Subscriber Server (HSS) is the main database in the IMS for storage of subscriber and service related data, including user identities, registration information, access parameters and the Initial Filter Criteria (IFC) used to trigger services. For example, the HSS provides support to the IMS nodes/functional entities implementing call and/or session functionalities in order to complete the routing/roaming procedures by solving authentication, authorization, naming/addressing resolution, location dependencies, etc. The HSS also contains functionality of a Home Location Register and Authentication Centre (HLR/AUC) to provide support to packet-switched domain entities, such as the Serving GPRS Support Node (SGSN) and Gateway GPRS Support Node (GGSN), and to circuit switched domain entities, such as the Mobile Switching Centres (MSC).

Within the service layer of the IMS network, Application Servers (ASs) are provided for implementing IMS service functionality. Application Servers provide services to end users in an IMS system, and may be connected either as end-points over the 3GPP defined Ma interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment (or indeed for the purpose of any SIP method, session or non-session related). The IFCs are received by the S-CSCF from an HSS during the IMS registration procedure as part of a user's Subscriber Profile.

Although the network nodes in the IMS Core Network should have a very high availability, some maintenance downtime and occasional failures are unavoidable. In addition, the communication links between the network elements are also subject to failures. For this reason 3GPP TS 23.380 (V10.1.0; June 2011) specifies a set of standardized procedures for automatic restoration after loss or corruption of data, including restoration procedures for scenarios in which an S-CSCF, which was successfully assigned to serve a UE during registration of the user of the UE, fails to process further signalling relating to a service for said UE. In particular, section 4.4.2 of 3GPP TS 23.380 describes a first scenario in relation to a session originating at the UE in which the S-CSCF that was assigned to serve the UE after the successful registration of the UE has lost the user profile data of the user or it is unable to trust the store data (e.g. due to a restart); and section 4.4.3 of 3GPP TS 23.380 describes a second scenario in relation to a session originating at the UE in which the S-CSCF that was assigned to serve the user of the UE after a successful registration becomes unreachable (e.g. due to internal error, or due a communication error).

By way of example, FIG. 2 is a signalling flow diagram illustrating an example of an implementation of the restoration procedures defined in section 4.4.3 of 3GPP TS 23.380 relating to the scenario in which a previously assigned S-CSCF has failed. The steps performed are as follows:
S101. The (originating) UE sends a SIP INVITE message to the P-CSCF that is serving the user in order to request establishment of an IMS session.
S102. The serving P-CSCF receives the SIP INVITE, and forwards the SIP INVITE message to S-CSCF 1, which was assigned to the UE during registration. In this regard, the P-CSCF will have learnt the identity of S-CSCF 1 from the Service-Route header fields received during the registration procedure.
S103. S-CSCF 1 is currently in failure, and the P-CSCF therefore determines that is unable to contact S-CSCF 1 after receiving no response to the SIP INVITE, despite any retransmissions.
S104. As a result, the P-CSCF returns a SIP 504 message to the UE in response to the SIP INVITE.
S105. The UE receives the SIP 504 message and, as a result, the UE initiates a new initial registration to the IMS by sending a SIP REGISTER message.
S106. The serving P-CSCF receives the SIP REGISTER message and forwards the SIP REGISTER message to a I-CSCF.
S107. The I-CSCF receives the SIP REGISTER message and therefore sends a

Diameter User-Authorization-Request (UAR) message to the HSS.
S108. The HSS receives the UAR message, and responds with a Diameter User-Authorization-Answer (UAA) message including the identity of the S-CSCF currently assigned to the user. In this example, a further S-CSCF (i.e. S-CSCF 2) has been assigned to the user at some time after the registration of the user with the IMS (e.g. as a result of a terminating session that occurred after the failure of S-CSCF 1).
S109. The I-CSCF receives the UAA message including the identity of S-CSCF 2 then forwards the SIP REGISTER message to S-CSCF 2.
S110. S-CSCF 2 receives the SIP REGISTER message, and responds with a SIP 200 OK message that includes the identity of S-CSCF 2 in the Service-Route header fields.
S111. The I-CSCF routes the SIP 200 OK message (including the Service-Route) back to the UE via the serving P-CSCF.
S112. The serving P-CSCF receives the SIP 200 OK message, saves the list of service route values in the Service-Route header fields, and forwards the 200 OK message to the UE.
S113. The UE receives the SIP 200 OK response to the SIP REGISTER, and then re-sends the SIP INVITE message in order to request establishment of the IMS session.
S114. The serving P-CSCF receives the SIP INVITE, and forwards the SIP INVITE message to S-CSCF 2, which is the S-CSCF identified in the list of service route values obtained from the Service-Route header fields of the SIP 200 OK response received in step S115.

According to 3GPP TS 23.380 (e.g. chapters 4.4.2 and 4.4.3), both of these scenarios can require that an S-CSCF returns an error response to the UE in order to trigger the UE to initiate a new registration with the IMS. In this regard, 3GPP TS 24.229 (V11.4.0; June 2012) specifies in section 5.2.6.3.2A that, if the P-CSCF is unable to successfully forward a request to the S-CSCF (e.g. because there is no response to the request and its retransmissions by the P-CSCF), then the P-CSCF shall reject the request by returning a SIP 504 (Server Time-out) response to the UE. Therefore, according to the 3GPP specifications, when a P-CSCF has received a session establishment request for a session originated by a UE, and has attempted to route the received session establishment request to the S-CSCF that was previously assigned to the user of the UE during registration within the IMS, but has not received a response (e.g. within a predefined time) from the S-CSCF, then the P-CSCF determines that it is unable to forward a session establishment request for the session to the previously assigned S-CSCF, and will return a SIP 504 response to the UE with respect to said request (e.g. as described above in S104). The 3GPP TS 24.229 (section 5.1.2A.1.6) also specifies that, if a UE receives a SIP 504 (Server Time-out) response, then the UE should initiate restoration procedures by performing an initial registration.

In short, the conventional restoration procedures disclosed by the 3GPP specifications require that, when the S-CSCF assigned to a user during registration with the IMS cannot process an IMS session for the user (e.g. because the S-CSCF has lost all user data following a failure or it is unable to trust any data after it resumes operation—as is the case illustrated in FIG. 2, chapter 4.4.2 of 3GPP TS 23.380—, or because the S-CSCF does not respond—e.g. chapter 4.4.3 of 3GPP TS 23.380), the UE must initiate a new registration with the IMS, such that a S-CSCF will be reassigned to the user (which can be the same assigned for its earlier registration, or a new one).

These restoration procedures therefore assume that the UE is able to receive and process a SIP 504 message received in response to a session establishment request, and that the processing of the SIP 504 message by the UE will result in the UE initiating a new registration with the IMS. However, this will not always be possible. In particular, it may not be possible for SIP signalling to transparently reach the UE, and/or the UE may not be SIP-capable. For example, the UE could be a circuit-switched UE that connects to the IMS via Mobile Softswitches (MSS), or even if the UE is SIP-capable, the UE may be connected to the IMS via Session Border Controllers (SBCs) that do not allow full transparent SIP signalling and that therefore might prevent a SIP 504 message from reaching the UE. In addition, even if the SIP signalling can reach the UE and the UE is SIP capable, the UE may not be configured to interpret a SIP 504 message as requiring the UE to initiate a new registration with the IMS. It would therefore be desirable to provide an alternative mechanism that for implementing IMS restoration that does not require the support of the UE.

### SUMMARY

It is an object of the present invention to provide methods and apparatus for processing an IMS session originated by a UE, after failure of a S-CSCF that was previously assigned to a user of the UE during registration with the IMS, wherein these methods do not require the support of the UE.

According to a first aspect there is provided a method of processing an IMS session originated by a UE after failure of a S-CSCF that was previously assigned to a user of the UE during registration with the IMS. The method comprises, at a P-CSCF:
upon determining that the P-CSCF is unable to forward a session establishment request for the session to the previously assigned S-CSCF, selecting an alternative S-CSCF from a S-CSCF pool, and sending the session establishment request for the session to the alternative S-CSCF.

The method may comprise determining that the P-CSCF is unable to forward a session establishment request for the session to the previously assigned S-CSCF when, after a predefined time, the previously assigned S-CSCF has not sent a response to a session establishment request for the session sent from the P-CSCF to the previously assigned S-CSCF.

The method may further comprise, if a response is received from the alternative S-CSCF that indicates that the session establishment request should be redirected to a specified SIP URI, checking if the specified SIP URI identifies the previously assigned S-CSCF, and, if the specified SIP URI does identify the previously assigned S-CSCF, then re-sending the session establishment request to the alternative S-CSCF and including in the session establishment request that is re-sent to the alternative S-CSCF an indication that the alternative S-CSCF must handle the session establishment request. The method may further comprise, if the specified SIP URI does not identify the previously assigned S-CSCF, then re-sending the session establishment request to a further S-CSCF identified by the specified SIP URI.

The session establishment request may be a SIP INVITE that has been received from the UE. The method may further comprise, prior to sending the SIP INVITE to a S-CSCF which is not the previously assigned S-CSCF, replacing an S-CSCF entry in a Route header field of the SIP INVITE received from the UE with a SIP URI of the S-CSCF to which the SIP INVITE message is to be sent.

The response received from the alternative S-CSCF may be a SIP 305 Use Proxy message that specifies a SIP URI to be used for redirecting the session establishment request included in a Contact header field.

The step of checking that the specified SIP URI identifies the previously assigned S-CSCF may comprise checking if the specified SIP URI is stored in a list of service route values that were stored by the P-CSCF during registration of the UE with the IMS.

According to a second aspect there is provided a method of processing an IMS session originated by a UE after failure of a S-CSCF that was previously assigned to a user of the UE during registration with the IMS. The method comprises, at a further S-CSCF:
receiving a session establishment request for the session from a P-CSCF; determining if a user profile for the user is stored within the further S-CSCF; and
if no user profile for the user is stored within the further S-CSCF, obtaining a

SIP URI identifying a S-CSCF currently assigned to the user, and informing the P-CSCF that the session establishment request should be redirected to the obtained SIP URI.

The method may further comprise, if, after informing the P-CSCF that the session establishment request should be redirected to the obtained SIP URI, a session establishment request for the session is received from the P-CSCF that includes an indication that the further S-CSCF must handle the session establishment request, then obtaining the user profile for the user and processing the session establishment request.

The step of obtaining the user profile for the user may comprise generating a request for a user profile of the user and including an information element indicating that the further S-CSCF must receive the user profile, sending the request for a user profile of the user to a HSS, and receiving a response from the HSS including the user profile of the user.

The step of obtaining a SIP URI identifying a S-CSCF currently assigned to the user may comprise generating and sending a request for a user profile of the user to a HSS, and receiving a response from the HSS, the response including a SIP URI identifying an S-CSCF currently assigned to the user.

The step of generating and sending a request for a user profile of the user to a HSS may comprise generating and sending a Diameter protocol Server-Assignment-Request message to the HSS, the Server-Assignment-Request message including a SIP URI of the further S-CSCF and including an information element specifying a Server Assignment Type of NO_ASSIGNMENT.

The step of receiving a response from the HSS may comprise receiving a Diameter protocol Server-Assignment-Answer message from the HSS, the Server-Assignment-Answer message including an information element specifying a Result Code of DIAMETER_IDENTITY_ALREADY_REGISTERED and a further information element comprising a SIP URI identifying an S-CSCF currently assigned to the user.

The step of informing the P-CSCF that the session establishment request should be redirected to the obtained SIP URI may comprise sending a session establishment response to the P-CSCF indicating that the session establishment request should be redirected to the obtained SIP URI. The session establishment response may be a SIP 305 Use Proxy message that specifies the obtained SIP URI to be used for redirecting the session establishment request in a Contact header field.

According to a third aspect there is provided a method of processing an IMS session originated by a UE after failure of a S-CSCF that was previously assigned to a user of the UE during registration with the IMS. The method comprises, at a HSS:
receiving a request for a user profile of the user from a further S-CSCF;
if the further S-CSCF is not the same as a S-CSCF currently assigned to the user and the request includes an information element indicating that the further S-CSCF must receive the user profile, sending a response to the further S-CSCF including the user profile of the user; and
if the further S-CSCF is not the same as a S-CSCF currently assigned to the user and the request does not include an information element indicating that the further S-CSCF must receive the user profile, sending a response to the further S-CSCF including a SIP URI identifying the S-CSCF currently assigned to the user.

According to a fourth aspect there is provided an apparatus configured to operate as an IMS P-CSCF. The apparatus comprises:
a receiver configured to receive a session establishment request for a session from a UE of a user;
a processor configured to determine an identity of a S-CSCF that was previously assigned to the user during registration with the IMS;
a transmitter configured to forward the session establishment request to the previously assigned S-CSCF;
the processor being further configured to determine that the P-CSCF is unable to forward a session establishment request for the session to the previously assigned S-CSCF, to select an alternative S-CSCF from a S-CSCF pool, and to cause the transmitter to send the session establishment request to the alternative S-CSCF.

The processor may be configured to determine that the P-CSCF is unable to forward a session establishment request for the session to the previously assigned S-CSCF when, after a predefined time, the receiver has not received a response from the previously assigned S-CSCF to a session establishment request sent to the previously assigned S-CSCF.

The receiver may be further configured to receive a response from the alternative S-CSCF that indicates that the session establishment request should be redirected to a specified SIP URI, and the processor is further configured to check if the specified SIP URI identifies the previously assigned S-CSCF.

If the specified SIP URI does identify the previously assigned S-CSCF, then the processor may be further configured to include in the session establishment request an indication that the alternative S-CSCF must handle the session establishment request and to cause the transmitter to re-send the session establishment request including the indication to the alternative S-CSCF.

If the specified SIP URI does not identify the previously assigned S-CSCF, then the processor may be further configured to cause the transmitter to re-send the session establishment request to a further S-CSCF identified by the specified SIP URI.

The session establishment request may be a SIP INVITE that has been received from the UE. The processor may be further configured to, prior to sending the SIP INVITE to a S-CSCF which is not the previously assigned S-CSCF, replace an S-CSCF entry in a Route header field of the SIP INVITE received from the UE with a SIP URI of the S-CSCF to which the SIP INVITE message is to be sent.

The response received from the alternative S-CSCF may be a SIP 305 Use Proxy message that specifies a SIP URI to be used for redirecting the session establishment request included in a Contact header field. The processor may be further configured to check that the specified SIP URI identifies the previously assigned S-CSCF by checking if the specified SIP URI is stored in a list of service route values that were stored by the P-CSCF during registration of the UE with the IMS.

According to a fifth aspect there is provided an apparatus configured to operate as an IMS S-CSCF. The apparatus comprises:
a memory configured to store user profiles for one or more users;
a receiver configured to receive, from a P-CSCF, a session establishment request for a session originated by a UE of a user;
a processor configured to determine if a user profile for the user is stored in the memory;
the processor being further configured to, if no user profile for the user is stored within the memory, obtain a SIP URI identifying a S-CSCF currently assigned to the user; and
a transmitter configured to inform the P-CSCF that the session establishment request should be redirected to the obtained SIP URI.

The receiver may be further configured to receive a session establishment request for the session from the P-CSCF that includes an indication that the S-CSCF must handle the session establishment request, and the processor may be further configured to obtain the user profile for the user and to process the session establishment request in accordance with the indication.

The processor may be further configured to obtain the user profile for the user by generating a request for a user profile of the user and including an information element indicating that the S-CSCF must receive the user profile, and causing the transmitter to send the request for a user profile of the user to a HSS. The processor may be further configured to obtain a SIP URI identifying a S-CSCF currently assigned to the user by generate a request for a user profile of the user, and causing the transmitter to send the request for a user profile of the user to a HSS. The receiver may be further configured to receive a response from the HSS.

The processor may be configured to generate a request for a user profile of the user that comprises a Diameter protocol Server-Assignment-Request message including a SIP URI of the S-CSCF and including an information element specifying a Server Assignment Type of NO_ASSIGNMENT.

The receiver may be configured to receive a response from the HSS that comprises a Diameter protocol Server-Assignment-Answer message including an information element specifying a Result Code of DIAMETER_IDENTITY_ALREADY_REGISTERED and a further information element comprising a SIP URI identifying an S-CSCF currently assigned to the user.

The processor may be configured to inform the P-CSCF that the session establishment request should be redirected to the obtained SIP URI by generating a session establishment response indicating that the session establishment request should be redirected to the obtained SIP URI and causing the transmitter to send the session establishment response to the P-CSCF.

The processor may be configured to generate a session establishment response that comprises a SIP 305 Use Proxy message that specifies the obtained SIP URI to be used for redirecting the session establishment request in a Contact header field.

According to a sixth aspect there is provided an apparatus configured to operate as an IMS HSS. The apparatus comprises:
a receiver configured to receive a request for a user profile of the user from a S-CSCF;
a processor configured to determine if the S-CSCF is not the same as a S-CSCF currently assigned to the user and, if the S-CSCF is not the same as a S-CSCF currently assigned to the user, to determine if the request includes an information element indicating that the S-CSCF must receive the user profile;
the processor being further configured to, if the request includes an information element indicating that the S-CSCF must receive the user profile, generate a response including the user profile of the user, and, if the request does not include an information element indicating that the further S-CSCF must receive the user profile, generating a response including a SIP URI identifying the S-CSCF currently assigned to the user; and
a transmitter configured to send the response to the S-CSCF.

### BRIEF DESCRIPTION OF THE DRAWINGS

Aspects of the present invention will now be further described, by way of example only, with reference to the accompanying figures.

FIG. 1 illustrates schematically the architecture of an IMS and its relationship to an IP-Connectivity Access Network;

FIG. 2 is a signalling flow diagram illustrating an example of an implementation of a conventional IMS restoration procedure;

FIG. 3 is a signalling flow diagram illustrating an example of an implementation of the methods described herein;

FIG. 4 illustrates schematically an example of a P-CSCF suitable for implementing the methods described herein;

FIG. 5 illustrates schematically an example of a S-CSCF suitable for implementing the methods described herein; and

FIG. 6 illustrates schematically an example of a HSS suitable for implementing the methods described herein.

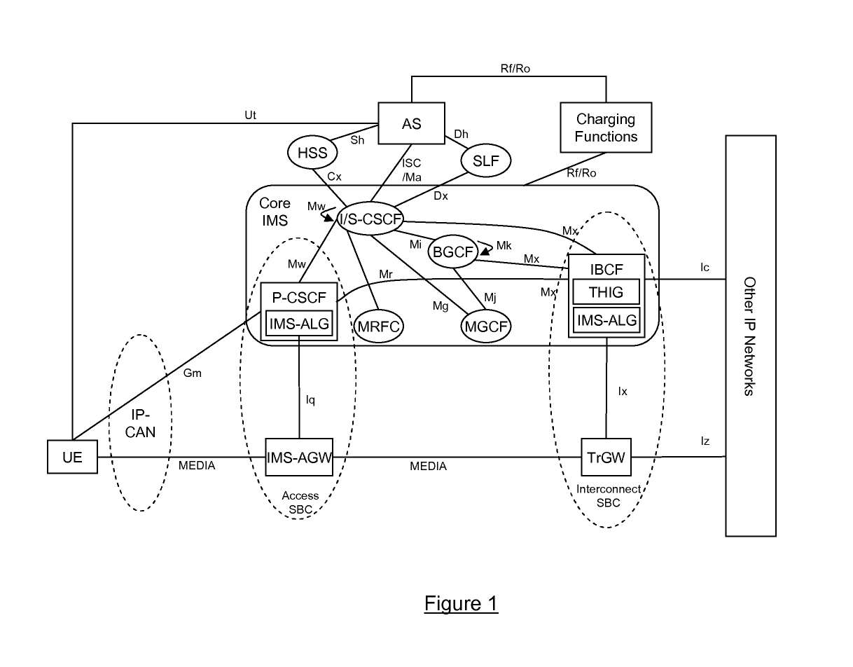

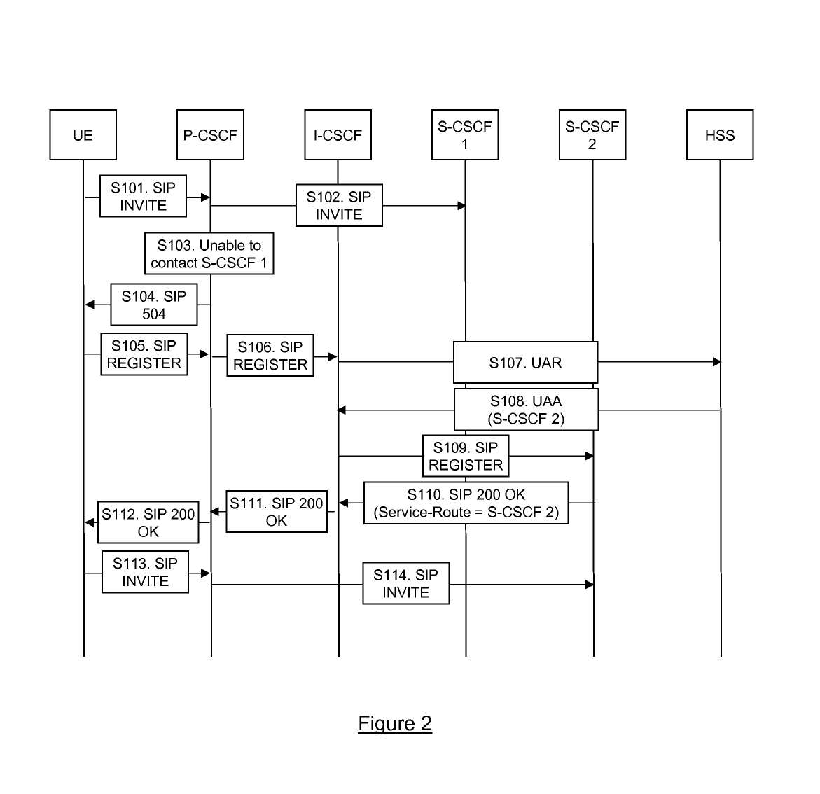

### DETAILED DESCRIPTION

There will now be described methods and apparatus for processing an IMS session originated by a UE, during failure of a S-CSCF that was previously assigned to a user of the UE during registration with the IMS, wherein these methods do not require the support of the UE.

In this regard, when a P-CSCF serving the user receives a session establishment request for the session from the UE of the user, the P-CSCF attempts to forward the session establishment request to the previously assigned S-CSCF. If the previously assigned S-CSCF is in failure, then P-CSCF will be unable to contact the previously assigned S-CSCF, and will therefore unable to forward the session establishment request. However, according to the methods described herein, rather than merely sending a failure response to the UE, the P-CSCF selects an alternative S-CSCF from a pool or list of alternative S-CSCFs, and forwards the session establishment request for the session to the selected alternative S-CSCF.

In addition, a S-CSCF that receives an originating request can make use of a Route header field to validate the routing information in the request. To do so, the S-CSCF can check that a Route header field in the received request matches one of its own identifiers (e.g. its own SIP URI), or can verify that a Route header field in the request matches a service route value received in the Service-Route header field during the last successful registration of the user. However, as the selected alternative S-CSCF was not involved in the registration, and therefore did not include it's identifier in the Service-Route header field, an identifier of the selected alternative S-CSCF will not be included in the Route header field of the session establishment request received from the UE. Therefore, in order to avoid the possibility that the selected alternative S-CSCF will reject the session establishment request sent by the P-CSCF, prior to sending the session establishment request to the alternative S-CSCF, the P-CSCF can be configured to replace an S-CSCF entry in a Route header field of the session establishment request received from the UE with an identifier of the alternative S-CSCF.

Upon receiving the session establishment request for the session from the P-CSCF, the selected alternative S-CSCF determines if it stores a user profile for the user. If the selected alternative S-CSCF does store a user profile for the user, then the selected alternative S-CSCF can handle/process the session establishment request in accordance with conventional IMS procedures. For example, this may be the case if the selected alternative S-CSCF has been assigned to the user as a result of a terminating session that occurred after the failure of S-CSCF. However, if the selected alternative S-CSCF does not store a user profile for the user, then the selected alternative S-CSCF obtains an identifier of a S-CSCF currently assigned to the user and informs the P-CSCF that the session establishment request should be redirected to the identified S-CSCF.

To obtain an identifier of a S-CSCF currently assigned to the user, the selected alternative S-CSCF can generate and send a request to register a user identity of the user to a HSS. When the HSS receives the request to register a user identity of the user from the selected alternative S-CSCF, the HSS will determine that the selected alternative S-CSCF is not the same as a S-CSCF currently assigned to the user. However, rather than sending a response to the previously assigned S-CSCF which merely indicates that the request has been unsuccessful, in accordance with conventional IMS procedures (i.e. as specified by 3GPP TS 29.228 V11.4.0; June 2012; chapter 6.1.2.1), the HSS sends a response to the selected alternative S-CSCF that identifies a further S-CSCF currently assigned to the user. In this regard, according to the conventional procedures specified in chapter 6.1.2.1 of 3GPP TS 29.228 V11.4.0, when the HSS receives a Server Assignment Request message (SAR; equivalent to the Cx operations Cx-Put and Cx-Pull defined in the corresponding 3GPP stage 2 specification TS 23.228) from a S-CSCF comprising a “Server Assignment Type value” set to “NO_ASSIGNMENT”, and the sending S-CSCF is not the currently assigned S-CSCF in respect of the user identified in the request according to the data stored by the HSS, the HSS should reply to the SAR message with a Server Assignment Answer (SAA) including an error code stating “DIAMETER_UNABLE_TO_COMPLY”; which would cause the S-CSCF to subsequently send a SIP 504 reply towards the UE. However, according to the methods described herein, in this same event, the HSS replies to the requesting S-CSCF with a SAA message with a different error code (such as “DIAMETER_ERROR_IDENTITY_ALREADY_REGISTERED”) and including an identifier of a further S-CSCF currently assigned to the user.

Upon receipt of the response from the HSS that includes an identifier of the S-CSCF currently assigned to the user of the UE, the selected alternative S-CSCF sends a session establishment response to the P-CSCF, which indicates that the session establishment request should be redirected to a further S-CSCF (i.e. the S-CSCF identified in the reply from the HSS). To do so, the selected alternative S-CSCF can generate and send a SIP 305 Use Proxy message that includes the identity of the further S-CSCF that is to be used for redirection in the Contact header field.

In this regard, according to the standards, a SIP 305 Use Proxy response to a request specifies that this single request (and not any future requests) should be redirected to a SIP URI given in the Contract header field. Consequently, the methods described herein optionally provide that the S-CSCF can include a Service Route Update Indicator in the SIP 305 Use Proxy response (e.g. conveyed as a new information element), which indicates that service route information held by a network element (e.g. the P-CSCF) for the user should be updated, so that future requests associated with the user are routed to the S-CSCF identified in the Contact header field. Therefore, when sending a session establishment response to the P-CSCF that indicates that the session establishment request should be redirected to the further S-CSCF, the selected alternative S-CSCF can optionally include an information element that comprises a Service Route Update Indicator. The Service Route Update Indicator then indicates that the “service route” information held by the P-CSCF for the user (i.e. from the initial registration) should be updated such that future requests received by the P-CSCF from the UE are routed to the S-CSCF indicated in the SIP 305 response. Otherwise, if a no Service Route Update Indicator is included, the P-CSCF receiving the SIP 305 response should consider the S-CSCF indicated in said response only for processing the current (e.g. the SIP INVITE it initially received from the UE, and that it tried to forward to a S-CSCF).

By way of example, the Service Route Indicator could be implemented using a SIP URI parameter that is included in the Contact header field of the IP 305 Use Proxy response with the SIP URI of the currently assigned S-CSCF. As an alternative example, the Service Route Indicator could be implemented using a cookie included in the user part of the SIP URI (e.g. “Contact: <sip:pcscf_orig%new_service_route@scscf2@ericsson.com;orig>”).

If the selected alternative S-CSCF does inform the P-CSCF that the session establishment request should be redirected to a specified S-CSCF, then the P-CSCF checks if the identified S-CSCF is the same as the previously assigned S-CSCF. If the identified S-CSCF is not the same as the previously assigned S-CSCF, then the P-CSCF redirects/resends the session establishment request to the identified S-CSCF. For example, this may be the case if the identified further S-CSCF has been assigned to the user as a result of a terminating session that occurred after the failure of S-CSCF. In this case, if the session establishment response also includes a Service Route Update Indicator, then the P-CSCF would be configured to update a list of service route values that were stored during registration of the UE with the IMS, in accordance with the Service Route Update Indicator. However, if the identified S-CSCF is the same as the previously assigned S-CSCF, then re-sends the session establishment request to the alternative S-CSCF, and includes in the re-sent session establishment request an indication that the selected alternative S-CSCF must handle/process the session establishment request.

In this regard, it is noted that the session establishment request that is re-sent to the alternative S-CSCF will comprise the same information as was included in the original/initial session establishment request received from the UE, and which was sent to the previously assigned S-CSCF from which no response was received, but will also include an additional information element explicitly indicating that the session establishment request must be handled by the recipient (i.e. by the alternative S-CSCF). Optionally, the Route header field of the session establishment request may also be modified, as described above, so as to ensure that the alternative S-CSCF will not reject the request.

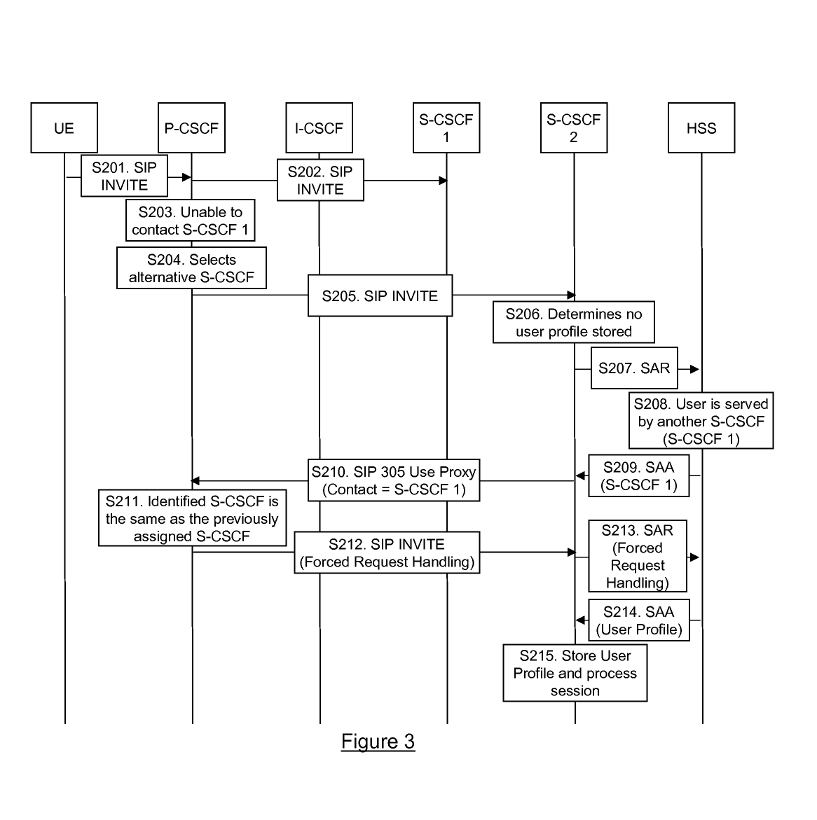

FIG. 3 is a signalling flow diagram illustrating an example of an implementation of the methods described herein. The steps performed are as follows:
S201. The (originating) UE sends a SIP INVITE message to the P-CSCF that is serving the user in order to request establishment of an IMS session.
S202. The serving P-CSCF receives the SIP INVITE, and forwards the SIP INVITE message to S-CSCF 1, which was assigned to the UE during registration. In this regard, the P-CSCF will have learnt the identity of S-CSCF 1 from the Service-Route header fields received during the registration procedure.
S203. S-CSCF 1 is currently in failure, and the P-CSCF therefore determines that is unable to contact S-CSCF 1 after receiving no response to the SIP INVITE, despite any retransmissions.
S204. The serving P-CSCF therefore selects an alternative S-CSCF, S-CSCF 2, from a pool or list of alternative S-CSCFs.
S205. The serving P-CSCF then forwards the SIP INVITE request for the session to S-CSCF 2. Prior to sending the SIP INVITE to S-CSCF 2, the serving P-CSCF may replace an S-CSCF entry in a Route header field of the SIP INVITE received from the UE with a SIP URI of the alternative S-CSCF.
S206. S-CSCF 2 receives the SIP INVITE from the serving P-CSCF, and determines if it stores a user profile for the user to which the SIP INVITE relates. In this example, S-CSCF 2 does not store a user profile for the user.
S207. S-CSCF 2 therefore attempts to obtain the user profile from the HSS. To do so, S-CSCF 2 sends a Diameter protocol Server-Assignment-Request (SAR) message to the HSS, with the Server Assignment Type set to NO_ASSIGNMENT, in order to register a user identity of the user.
S208. The HSS receives the SAR message, and checks whether the S-CSCF requesting the user profile is assigned for the user. In this example, the HSS determines S-CSCF 2 is not assigned to the user, as S-CSCF 1 was assigned to the user during registration and there has not subsequently been a reassignment of the S-CSCF assigned for the user.
S209. In accordance with the methods described herein, the HSS therefore responds to S-CSCF 2 identifying another S-CSCF that is currently assigned to the user. To do so, the HSS generates and sends a Diameter protocol Server-Assignment-Answer (SAA) message to S-CSCF 2 with the Result-Code set to DIAMETER_{—} IDENTITY_ALREADY_REGISTERED, and including the identity of the S-CSCF currently assigned to the user (i.e. S-CSCF 1).
S210. S-CSCF 2 receives the SAA message from the HSS and, as a result, generates and sends a response to the P-CSCF indicating that the SIP INVITE should be redirected to the currently assigned S-CSCF, S-CSCF 1. To do so, S-CSCF 2 uses a SIP 305 Use Proxy message that includes the identity of S-CSCF 1 that is to be used for redirection in the Contact header field. In addition, as the standards specify that a SIP 305 Use Proxy message requires that only a single SIP request (and not any future requests) is to be redirected), the S-CSCF 1 also includes an information element in the SIP 305 Use Proxy response sent to the P-CSCF that indicates that future service requests from this UE should also be routed to the currently assigned S-CSCF (i.e. S-CSCF 1, in the illustrated example). To do so, the S-CSCF 2 can include a Service Route Update Indicator, which indicates that the “service route” information held by the P-CSCF for the user should be updated according to the Contact header field received (i.e. overwritten with the new value received in the Contact header field), so that future requests received by the P-CSCF from the UE are routed to the currently assigned S-CSCF.
S211. The P-CSCF receives the SIP 305 Use Proxy response message, and therefore checks if the S-CSCF identified in the response is the same as the previously assigned S-CSCF (i.e. S-CSCF 1). In this example, the identified S-CSCF is the same as the previously assigned S-CSCF.
S212. As a result, the P-CSCF includes, in the SIP INVITE, a Forced Request Handling indication (e.g. by way of an information element expressing explicitly said request), and re-sends the SIP INVITE to S-CSCF 2. The Forced Request Handling indication indicates to the recipient S-CSCF (i.e. S-CSCF 2) that it must handle this (single) SIP INVITE request and, thus, that it is required to obtain the necessary user data with respect to the user of the UE that originally sent the SIP INVITE request (which can imply also obtaining data related to said UE).
S213. S-CSCF 2 receives the SIP INVITE message, including the Forced Request Handling indication, and thereby determines that it must handle this request. S-CSCF 2 therefore again attempts to obtain the user profile from the HSS. To do so, S-CSCF 2 sends a further Diameter Server-Assignment-Request (SAR) message to the HSS, and includes a Forced Request Handling indication in the SAR message. The Forced Request Handling indication sent to the HSS indicates to the HSS that is must respond with the user profile for the user.
S214. The HSS receives the further SAR message, including the Forced Request Handling indication, and thereby determines that it must respond with the user profile for the user. The HSS therefore retrieves the user profile for the user, and includes the user profile in a further SAA response message sent to S-CSCF 2.
S215. S-CSCF 2 receives the SAA message including the user profile. S-CSCF 2, therefore temporarily stores the user profile so that it can process the SIP INVITE in accordance with conventional IMS procedures.

When the P-CSCF selects an alternative S-CSCF from a pool or list of alternative S-CSCFs, and forwards the session establishment request for the session to the selected alternative S-CSCF.

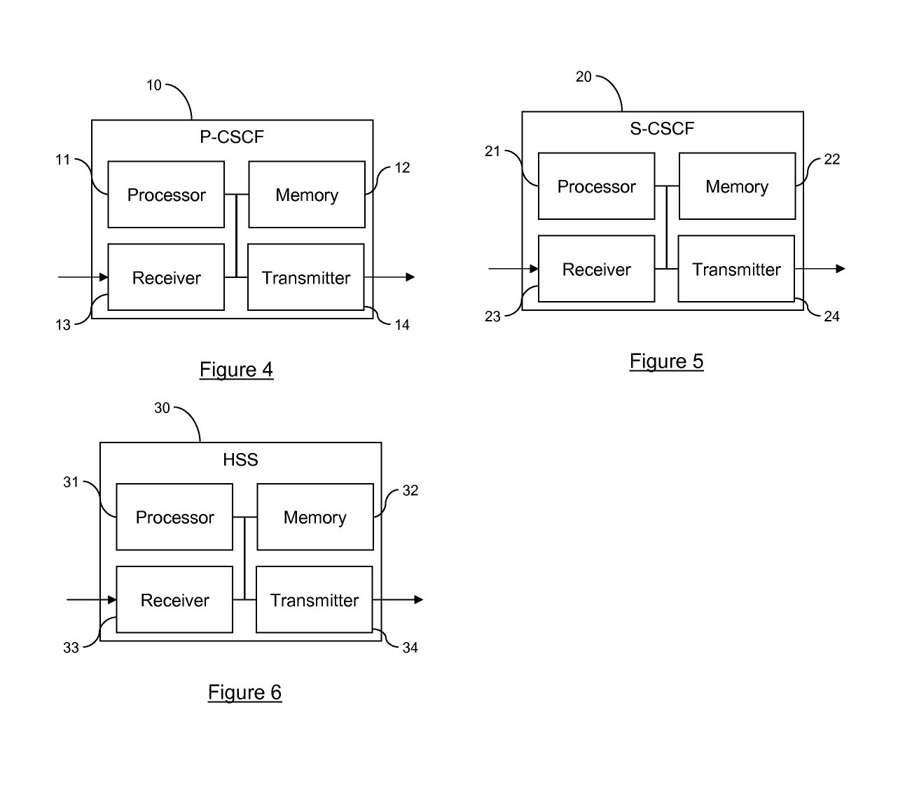

FIG. 4 illustrates schematically an example of a P-CSCF 10 suitable for implementing the methods described herein. The P-CSCF 10 can be implemented as a combination of computer hardware and software. The P-CSCF 10 comprises a processor 11, a memory 12, a receiver 13 and a transmitter 14. The memory 12 stores the various programs/executable files that are implemented by the processor 11, and also provides a storage unit for any required data. For example, the data stored by the memory 12 can include but is not limited to a list of service route values for a served user that has registered with the IMS and a pool or list of alternative S-CSCFs. The programs/executable files stored in the memory 12, and implemented by the processor 11, include but are not limited to a S-CSCF identification unit, a S-CSCF failure detection unit, an alternative S-CSCF selection unit, and a message processing unit, wherein these units are configured to implement the relevant aspects of the methods described.

FIG. 5 illustrates schematically an example of a S-CSCF 20 suitable for implementing the methods described herein. The S-CSCF 20 can be implemented as a combination of computer hardware and software. The S-CSCF 20 comprises a processor 21, a memory 22, a receiver 23 and a transmitter 24. The memory 22 stores the various programs/executable files that are implemented by the processor 21, and also provides a storage unit for any required data. For example, the data stored by the memory 12 can include but is not limited to user profile data for a plurality of users that has been obtained from a HSS. The programs/executable files stored in the memory 22, and implemented by the processor 21, include but are not limited to a user profile retrieval unit, and a message processing unit, wherein these units are configured to implement the relevant aspects of the methods described.

FIG. 6 illustrates schematically an example of a HSS 30 suitable for implementing the methods described herein. The HSS 30 can be implemented as a combination of computer hardware and software. The HSS 30 comprises a processor 31, a memory 32, a receiver 33 and a transmitter 34. The memory 32 stores the various programs/executable files that are implemented by the processor 31, and also provides a storage unit for any required data. For example, the data stored by the memory 32 can include but is not limited to user profile data for a plurality of users, together with information regarding the S-CSCF currently assigned to each registered user. The programs/executable files stored in the memory 32, and implemented by the processor 31, include but are not limited to a S-CSCF identification unit, a user profile retrieval unit, and a message processing unit, wherein these units are configured to implement the relevant aspects of the methods described.

The methods described herein provide an alternative mechanism for implementing IMS restoration that does not require the support of the UE, and that does not cause the UE to suffer a service disruption.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. For example, in the illustrated example signalling flow diagrams described above, only those messages and headers that are of particular relevance are shown. Those skilled in the art will be aware those messages and headers that have not been included in this illustration.

1. A method of processing an IP Multimedia Subsystem, IMS, session originated by a User Equipment, UE, after failure of a Serving Call Session Control Function, S-CSCF, that was previously assigned to a user of the UE during registration with the IMS, the method comprising, at a Proxy Call Session Control Function, P-CSCF:
upon determining that the P-CSCF is unable to forward a session establishment request for the session to the previously assigned S-CSCF, selecting an alternative S-CSCF from a S-CSCF pool, and sending the session establishment request for the session to the alternative S-CSCF.

2. The method of claim 1, wherein it is determined that the P-CSCF is unable to forward a session establishment request for the session to the previously assigned S-CSCF when, after a predefined time, the previously assigned S-CSCF has not sent a response to a session establishment request for the session sent from the P-CSCF to the previously assigned S-CSCF.

3. The method of claim 1, further comprising:
if a response is received from the alternative S-CSCF that indicates that the session establishment request should be redirected to a specified SIP URI, checking if the specified SIP URI identifies the previously assigned S-CSCF; and
if the specified SIP URI does identify the previously assigned S-CSCF, then re-sending the session establishment request to the alternative S-CSCF and including in the session establishment request that is re-sent to the alternative S-CSCF an indication that the alternative S-CSCF must handle the session establishment.

4. The method of claim 3, further comprising:
if the specified SIP URI does not identify the previously assigned S-CSCF, then re-sending the session establishment request to a further S-CSCF identified by the specified SIP URI.

5. The method of claim 1, wherein the session establishment request is a SIP INVITE that has been received from the UE.

6. The method of claim 5, further comprising:
prior to sending the SIP INVITE to a S-CSCF which is not the previously assigned S-CSCF, replacing an S-CSCF entry in a Route header field of the SIP INVITE received from the UE with a SIP URI of the S-CSCF to which the SIP INVITE message is to be sent.

7. The method of claim 3, wherein the response received from the alternative S-CSCF is a SIP 305 Use Proxy message that specifies a SIP URI to be used for redirecting the session establishment request included in a Contact header field.

8. The method of claim 7, wherein the step of checking that the specified SIP URI identifies the previously assigned S-CSCF comprises:
checking if the specified SIP URI is stored in a list of service route values that were stored by the P-CSCF during registration of the UE with the IMS.

9. A method of processing an IP Multimedia Subsystem, IMS, session originated by a User Equipment, UE, after failure of a Serving Call Session Control Function, S-CSCF, that was previously assigned to a user of the UE during registration with the IMS, the method comprising, at a further S-CSCF:
receiving a session establishment request for the session from a Proxy Call Session Control Function, P-CSCF;
determining if a user profile for the user is stored within the further S-CSCF; and
if no user profile for the user is stored within the further S-CSCF, obtaining a SIP URI identifying a S-CSCF currently assigned to the user, and informing the P-CSCF that the session establishment request should be redirected to the obtained SIP URI.

10. The method of claim 9, further comprising:
if, after informing the P-CSCF that the session establishment request should be redirected to the obtained SIP URI, a session establishment request for the session is received from the P-CSCF that includes an indication that the further S-CSCF must handle the session establishment request (S212), then obtaining the user profile for the user and processing the session establishment request.

11. The method of claim 10, wherein the step of obtaining the user profile for the user comprises:
generating a request for a user profile of the user and including an information element indicating that the further S-CSCF must receive the user profile;
sending the request for a user profile of the user to a Home Subscriber Server, HSS; and
receiving a response from the HSS including the user profile of the user.

12. The method of claim 9, wherein the step of obtaining a SIP URI identifying a S-CSCF currently assigned to the user comprises:
generating and sending a request for a user profile of the user to a Home Subscriber Server, HSS; and
receiving a response from the HSS, the response including a SIP URI identifying an S-CSCF currently assigned to the user.

13. The method of claim 12, wherein the step of generating and sending a request for a user profile of the user to a HSS comprises:
generating and sending a Diameter protocol Server-Assignment-Request message to the HSS, the Server-Assignment-Request message including a SIP URI of the further S-CSCF and including an information element specifying a Server Assignment Type of NO_ASSIGNMENT.

14. The method of claim 12, wherein the step of receiving a response from the HSS comprises:
receiving a Diameter protocol Server-Assignment-Answer message from the HSS, the Server-Assignment-Answer message including an information element specifying a Result Code of DIAMETER_IDENTITY_ALREADY_REGISTERED and a further information element comprising a SIP URI identifying an S-CSCF currently assigned to the user.

15. The method of claim 9, wherein the step of informing the P-CSCF that the session establishment request should be redirected to the obtained SIP URI comprises:
sending a session establishment response to the P-CSCF indicating that the session establishment request should be redirected to the obtained SIP URI.

16. The method of claim 15, wherein the session establishment response is a SIP 305 Use Proxy message that specifies the obtained SIP URI to be used for redirecting the session establishment request in a Contact header field.

17. A method of processing an IP Multimedia Subsystem, IMS, session originated by a User Equipment, UE, after failure of a Serving Call Session Control Function, S-CSCF, that was previously assigned to a user of the UE during registration with the IMS, the method comprising, at a Home Subscriber Server, HSS:
receiving a request for a user profile of the user from a further S-CSCF;
if the further S-CSCF is not the same as a S-CSCF currently assigned to the user and the request includes an information element indicating that the further S-CSCF must receive the user profile, sending a response to the further S-CSCF including the user profile of the user; and
if the further S-CSCF is not the same as a S-CSCF currently assigned to the user and the request does not include an information element indicating that the further S-CSCF must receive the user profile, sending a response to the further S-CSCF including a SIP URI identifying the S-CSCF currently assigned to the user.

18. An apparatus configured to operate as an IP Multimedia Subsystem, IMS, Proxy Call Session Control Function, P-CSCF, the apparatus comprising:
a receiver configured to receive a session establishment request for a session from a User Equipment, UE, of a user;
a processor configured to determine an identity of a Serving Call Session Control Function, S-CSCF, that was previously assigned to the user during registration with the IMS;
a transmitter configured to forward the session establishment request to the previously assigned S-CSCF; and
the processor being further configured to determine that the P-CSCF is unable to forward a session establishment request for the session to the previously assigned S-CSCF, to select an alternative S-CSCF from a S-CSCF pool, and to cause the transmitter to send the session establishment request to the alternative S-CSCF.

19. The apparatus of claim 18, wherein the processor is configured to determine that the P-CSCF is unable to forward a session establishment request for the session to the previously assigned S-CSCF when, after a predefined time, the receiver has not received a response from the previously assigned S-CSCF to a session establishment request sent to the previously assigned S-CSCF.

20. The apparatus of claim 18, wherein the receiver is further configured to receive a response from the alternative S-CSCF that indicates that the session establishment request should be redirected to a specified SIP URI, and the processor is further configured to check if the specified SIP URI identifies the previously assigned S-CSCF.

21. The apparatus of claim 20, wherein, if the specified SIP URI does identify the previously assigned S-CSCF, then the processor is further configured to include in the session establishment request an indication that the alternative S-CSCF must handle the session establishment request and to cause the transmitter to re-send the session establishment request including the indication to the alternative S-CSCF.

22. The apparatus of claim 20, wherein, if the specified SIP URI does not identify the previously assigned S-CSCF, then the processor is further configured to cause the transmitter to re-send the session establishment request to a further S-CSCF identified by the specified SIP URI.

23. The apparatus of claim 18, wherein the session establishment request is a SIP INVITE that has been received from the UE.

24. The apparatus of claim 23, wherein the processor is further configured to, prior to sending the SIP INVITE to a S-CSCF which is not the previously assigned S-CSCF, replace an S-CSCF entry in a Route header field of the SIP INVITE received from the UE with a SIP URI of the S-CSCF to which the SIP INVITE message is to be sent.

25. The apparatus of claim 20, wherein the response received from the alternative S-CSCF is a SIP 305 Use Proxy message that specifies a SIP URI to be used for redirecting the session establishment request included in a Contact header field.

26. The apparatus of claim 25, wherein the processor is further configured to check that the specified SIP URI identifies the previously assigned S-CSCF by checking if the specified SIP URI is stored in a list of service route values that were stored by the P-CSCF during registration of the UE with the IMS.

27. An apparatus configured to operate as an IP Multimedia Subsystem, IMS, Serving Call Session Control Function, S-CSCF, the apparatus comprising:
a memory configured to store user profiles for one or more users;
a receiver configured to receive, from a Proxy Call Session Control Function, P-CSCF, a session establishment request for a session originated by a User Equipment, UE, of a user;
a processor configured to determine if a user profile for the user is stored in the memory;
the processor being further configured to, if no user profile for the user is stored within the memory, obtain a SIP URI identifying a S-CSCF currently assigned to the user; and
a transmitter configured to inform the P-CSCF that the session establishment request should be redirected to the obtained SIP URI.

28. The apparatus of claim 27, wherein the receiver is further configured to receive a session establishment request for the session from the P-CSCF that includes an indication that the S-CSCF must handle the session establishment request, and the processor is further configured to obtain the user profile for the user and to process the session establishment request in accordance with the indication.

29. The apparatus of claim 28, wherein the processor is further configured to obtain the user profile for the user by generating a request for a user profile of the user and including an information element indicating that the S-CSCF must receive the user profile, and causing the transmitter to send the request for a user profile of the user to a Home Subscriber Server, HSS.

30. The apparatus of claim 27, wherein the processor is further configured to obtain a SIP URI identifying a S-CSCF currently assigned to the user by generate a request for a user profile of the user, and causing the transmitter to send the request for a user profile of the user to a Home Subscriber Server, HSS.

31. The apparatus of claim 30, wherein the receiver is further configured to receive a response from the HSS.

32. The apparatus of claim 30, wherein the processor is configured to generate a request for a user profile of the user that comprises a Diameter protocol Server-Assignment-Request message including a SIP URI of the S-CSCF and including an information element specifying a Server Assignment Type of NO_ASSIGNMENT.

33. The apparatus claim 31, wherein the receiver is configured to receive a response from the HSS that comprises a Diameter protocol Server-Assignment-Answer message including an information element specifying a Result Code of DIAMETER_IDENTITY_ALREADY_REGISTERED and a further information element comprising a SIP URI identifying an S-CSCF currently assigned to the user.

34. The apparatus of claim 27, wherein the processor is configured to inform the P-CSCF that the session establishment request should be redirected to the obtained SIP URI by generating a session establishment response indicating that the session establishment request should be redirected to the obtained SIP URI and causing the transmitter to send the session establishment response to the P-CSCF.

35. The apparatus of claim 34, wherein the processor is configured to generate a session establishment response that comprises a SIP 305 Use Proxy message that specifies the obtained SIP URI to be used for redirecting the session establishment request in a Contact header field.

36. An apparatus configured to operate as an IP Multimedia Subsystem, IMS, Home Subscriber Server, HSS, the apparatus comprising:
a receiver configured to receive a request for a user profile of the user from a S-CSCF;
a processor configured to determine if the S-CSCF is not the same as a S-CSCF currently assigned to the user and, if the S-CSCF is not the same as a S-CSCF currently assigned to the user, to determine if the request includes an information element indicating that the S-CSCF must receive the user profile;
the processor being further configured to, if the request includes an information element indicating that the S-CSCF must receive the user profile, generate a response including the user profile of the user, and, if the request does not include an information element indicating that the further S-CSCF must receive the user profile, generating a response including a SIP URI identifying the S-CSCF currently assigned to the user; and
a transmitter configured to send the response to the S-CSCF.
